(19) United States
(12) Patent Application Publication
(10) Pub. No.: US 2025/0316000 A1
(43) Pub. Date: Oct. 9, 2025

(54) Multimodal Scene Graph for Generating Media Elements

(71) Applicant: Meta Platforms Technologies, LLC, Menlo Park, CA (US)

(72) Inventors: Michael Andrew HOWARD, Reading (GB); Leon ZHAN, Tysons, VA (US); Junian IOFFE, Brooklyn, NY (US); Gheorghe POSTELNICU, London (GB); Timothy JACOBY, Atherton, CA (US); Ya WANG, Champaign, IL (US); Nikola OTASEVIC, London (GB)

(21) Appl. No.: 18/629,343

(22) Filed: Apr. 8, 2024

(51) Int. Cl. G06T 11/60; G06F 16/958; G06T 7/20; G06T 7/70; G06T 13/40; G06T 13/80; G06T 15/20

(52) U.S. Cl. CPC G06T 11/60; G06F 16/958; G06T 7/20; G06T 7/70; G06T 13/40; G06T 13/80; G06T 15/20; G06T 2207/20081; G06T 2207/30196; G06T 2210/61

(57) ABSTRACT

Aspects of the present disclosure are directed to generating media element(s) using a multimodal scene graph. A scene manager can process visual information, such as video, images, and/or a recorded artificial relay scene, and generate a multimodal scene graph that comprises components and metadata generated via the processing. The scene manager can utilize the multimodal scene graph to generate social media elements, such as images, video, and/or artificial reality scenes. For example, a video of a user can be converted to a multimodal scene graph, which can be used to generate one or more images (e.g., memes, animated images, stickers, etc.), such as an image that represents the user via an avatar of the user. This generated media can be shared with other social platform users, and the stored multimodal scene graph can be accessed by the others to generate variations of the media.

### TECHNICAL FIELD

The present disclosure is directed to generating a media element using a multimodal scene graph.

### BACKGROUND

User interactions on social platforms have become increasingly popular. In addition, user interactions often include a multimedia component, such as an image or video. However, conventional systems lack intuitive and practical mechanisms to create, edit, and/or share content that encompasses different varieties, forms, and media types. For example, a given image or video may be shared numerous times by many social media users, however the ability to create, edit, and transform this media is limited to predefined constructs, such as predefined filters that can be applied to images or video captured on the camera of a mobile device.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a conceptual diagram illustrating a multimodal scene graph and rendered media element(s).

FIG. 5B is a conceptual diagram illustrating a multimodal scene graph converted from multiple underlying instances of visual information.

FIG. 6 is a conceptual diagram of a kinematic model for a detected object.

FIG. 7A is an example tool for interacting with an artificial reality scene related to a multimodal scene graph.

FIG. 7B is an example tool for interacting with an image or video related to a multimodal scene graph.

FIG. 8 is a flow diagram illustrating a process used in some implementations of the present technology for converting visual information into a multimodal scene graph.

FIG. 9 is a flow diagram illustrating a process used in some implementations of the present technology for generating component data for a multimodal scene graph and converting detected movement data into target movement data.

FIG. 10 is a flow diagram illustrating a process used in some implementations of the present technology for rendering and publishing media element(s) using a multimodal scene graph.

FIG. 11 is a flow diagram illustrating a process used in some implementations of the present technology for editing a multimodal scene graph and rendering media element(s).

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure are directed to generating media element(s) using a multimodal scene graph. A scene manager can process visual information, such as video, images, and/or a recorded artificial relay scene, and generate a multimodal scene graph that comprises components and metadata generated via the processing. For example, one or more trained machine learning models can recognize objects in the visual information and store component data for the objects, such as structural data, animation data, and/or location data. The scene manager and/or trained machine learning model(s) can also recognize and store metadata for the multimodal scene graph, such as a background, audio, and the like. The scene manager can utilize the multimodal scene graph to generate social media elements, such as images, video, and/or artificial reality scenes. For example, a video of a user can be converted to a multimodal scene graph, which can be used to generate one or more images (e.g., memes, animated images, stickers, etc.), such as an image that represents the user via an avatar of the user. This generated media can be shared with other social platform users, and the stored multimodal scene graph can be accessed by the others to generate variations of the image. For example, variations can include a similar image with a swapped avatar, an additional avatar, a replaced caption, a replaced background, and other suitable variations.

The scene manager can generate the multimodal scene graph by converting the underlying visual information into serialized data, such as component data for objects in the underlying visual information (e.g., people, objects, etc.) and metadata (e.g., background, audio, etc.). For example, trained machine learning models can recognize data about the objects in the visual information, such as object structure, object movement, object location with respect to the visual information, and the like. For each recognized object, component data can be stored, such as the object's recognized structure, animation data based on the object's recognized movements, and location data with respect to the overall visual information (e.g., image, video, artificial realty scene), such as two-dimensional and/or three-dimensional coordinates.

The scene manager can then generate media elements using the multimodal scene graph. For example, the underlying visual information can be a video of a user, and a generated media element can be an image (e.g., animated image, sticker, etc.), such as a two-dimensional image. In some implementations, the generated image can correspond to the video at a particular point in time. For example, in the video, the user can move into a variety of poses and the generated image can correspond to a particular user pose at a particular time in the video. In some implementations, the scene manager can replace the video of the user with an avatar of the user when rendering the image. For example, the rendered avatar can be in a pose that corresponds to the user's pose at the particular point in time in the video. In some implementations, the generated media element can be an animated image or a video, and the rendered avatar can be animated based on the user's movements in the underlying video.

In some implementations, the underlying visual information can be an artificial reality scene that comprises avatar(s), other virtual object(s), a background, a three-dimensional environment, and any other suitable scene elements. The scene manager and/or machine learning model(s) can process the artificial reality scene to store component data for the multimodal scene graph that corresponds to recognized object(s) (e.g., avatars, virtual object(s), etc.), such as structural data, motion dynamics, location data, and the like. The scene manager and/or machine learning model(s) can also process the artificial reality scene to store metadata for the multimodal scene graph, such as the background, virtual environment (e.g., three-dimensional space), audio, and the like. In some implementations, the scene manager can generate a media element using a multimodal scene graph based on an artificial reality scene by rendering the media from a particular perspective with respect to the artificial reality scene. For example, a video and/or image of the artificial reality scene can be rendered from a perspective (e.g., camera view) in the artificial reality scene. In some implementations, an artificial reality scene player can display the artificial reality scene from different perspectives, and one of these perspectives can be used to render the media elements (e.g., images, video, etc.).

Implementations support social interaction using editable and publishable media elements generated via multimodal scene graphs. Social users can access multimodal scene graphs used to render social media elements and create variations of the social media elements, such as images and/or video with replaced avatar(s), added avatar(s), replaced audio, edited text/caption(s), replaced background(s) and the like. In some implementations, the edits to a media element can be performed via a multimodal scene graph captured by an editing user. For example, a first user can access a first multimodal scene graph used to render a first image so that the first user can generate an alternative version of the first image. The scene manager can convert a video that captures the first user into a second multimodal scene graph that includes component data that represents the first user as captured in the video. The first user can, via the scene manager, augment the first multimodal scene graph by adding this component data (e.g., that corresponds to the first user as captured in the video) from the second multimodal scene graph to the first multimodal scene graph. The scene manager can then render an image, using the augmented multimodal scene graph, that is an augmented version of the first image, such as a version of the first image that includes an avatar of the first user (e.g., avatar posed in a specific pose that corresponds to the first user in the captured video, animated avatar that corresponds to movements of the first user in the captured video, etc.). Multi-modal scene graphs can undergo numerous edits and/or support variations of rendered media elements, thus providing a social interaction mechanism with a high degree of individualization.

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

While some conventional software permits customization of sharable media, such as images and/or videos, this conventional software includes rigid structures and limited functionality. For example, a filter or visual effects can be applied to a captured image or video, however conventional systems lack the support to generate different variations of media with structural changes.

Implementations disclosed herein leverage multimodal scene graphs that represent visual information (e.g., videos, images, artificial reality scenes, etc.) in a format that is conducive to sharing, editing, and variation. For example, a variety of media elements can be generated from the multimodal scene graphs, such as various types of images and/or videos with different avatars, objects, backgrounds, captions, etc. The multimodal scene graphs are conducive to social interactions, as social platform users can access and/or edit these scene graphs to support personalization. In some scenarios, a multimodal scene graph can be edited multiple times by multiple users, and these edited graphs can be used to generate a large number of media elements with high degrees of variation. Although these media elements vary, because they share a common source (i.e., the original multimodal scene graph prior to the edits), the media elements can hold a commonality that associates them together. This commonality in combination with the personalization accomplished via the editing/variation can spark social engagement among social platform users.

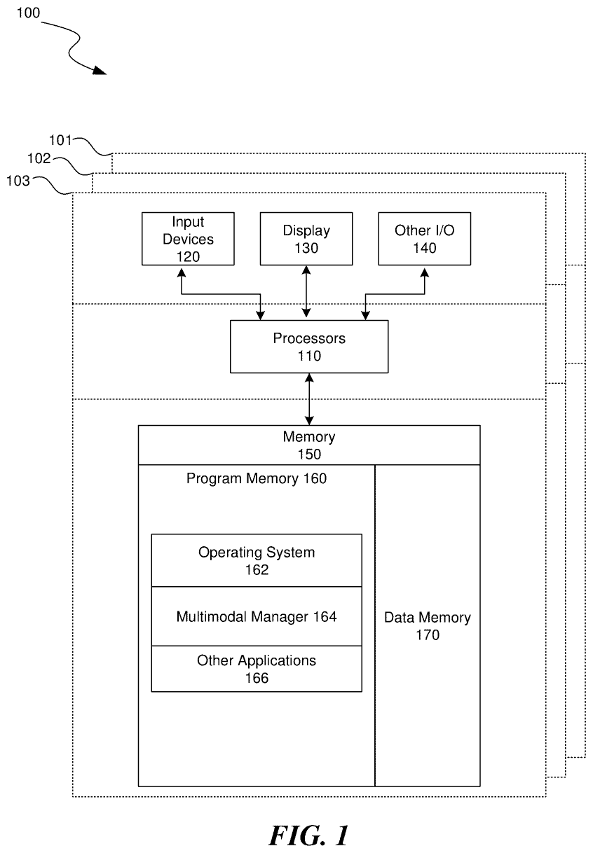

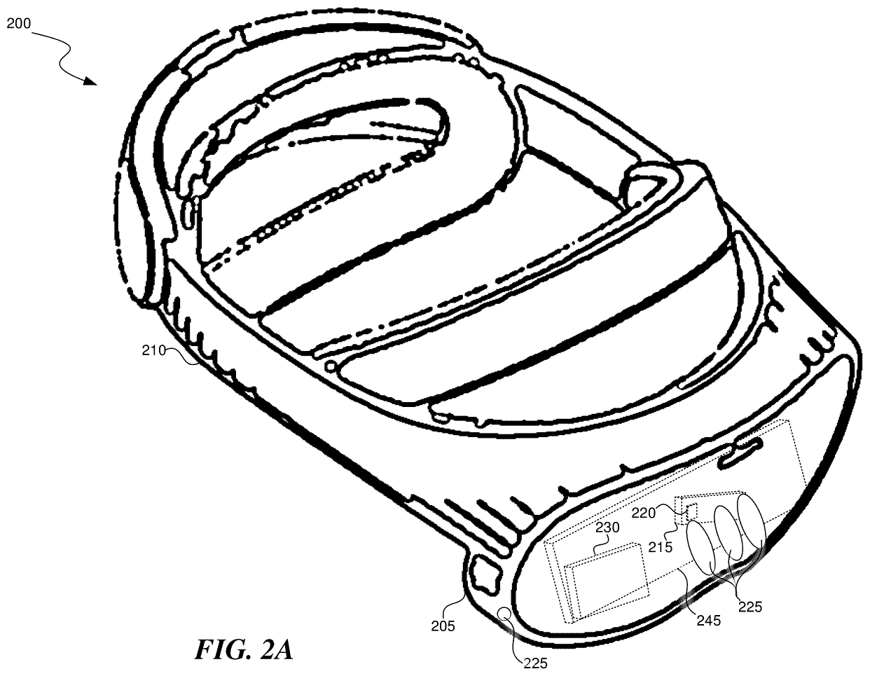

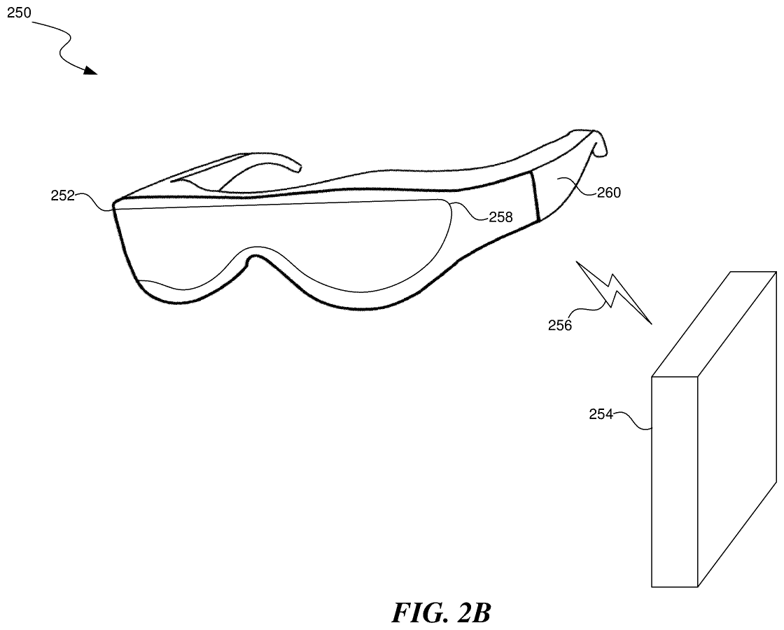

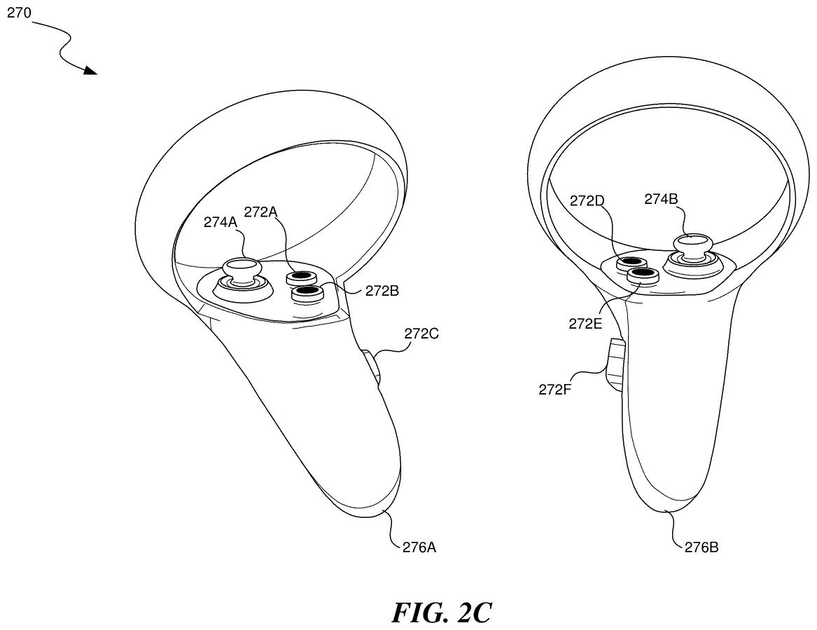

Several implementations are discussed below in more detail in reference to the figures. FIG. 1 is a block diagram illustrating an overview of devices on which some implementations of the disclosed technology can operate. The devices can comprise hardware components of a computing system 100 that generate a media element(s) using a multimodal scene graph. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, multimodal manager 164, and other application programs 166. Memory 150 can also include data memory 170 that can include, e.g., avatar data, object/component data, video and/or images, XR scene component data, audio data, configuration data, settings, user options or preferences, etc., which can be provided to the program memory 160 or any element of the computing system 100.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3 DoF) or six degrees of freedom (6 DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world.

Similarly to the HMD 200, the HMD system 250 can also include motion and position tracking units, cameras, light sources, etc., which allow the HMD system 250 to, e.g., track itself in 3 DoF or 6 DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3 DoF or 6 DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

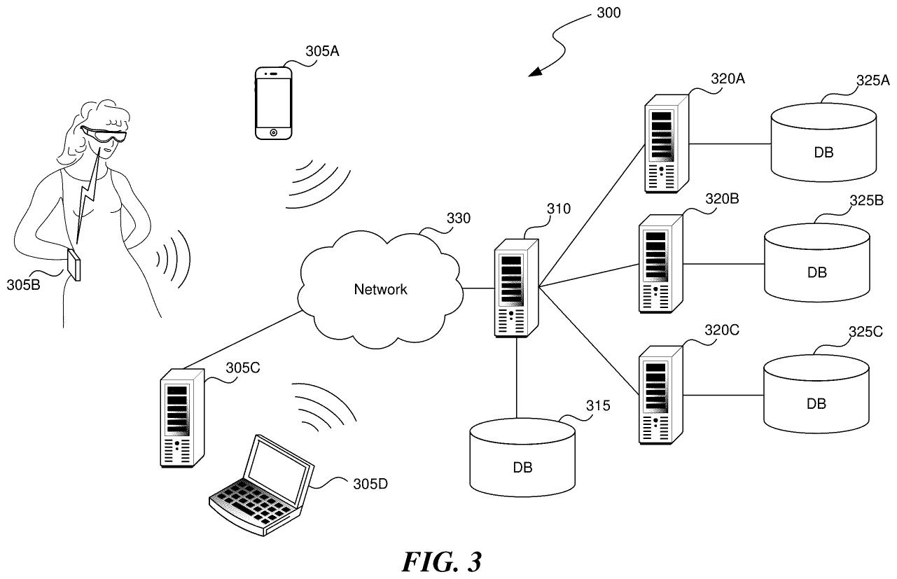

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

In some implementations, servers 310 and 320 can be used as part of a social network. The social network can maintain a social graph and perform various actions based on the social graph. A social graph can include a set of nodes (representing social networking system objects, also known as social objects) interconnected by edges (representing interactions, activity, or relatedness). A social networking system object can be a social networking system user, nonperson entity, content item, group, social networking system page, location, application, subject, concept representation or other social networking system object, e.g., a movie, a band, a book, etc. Content items can be any digital data such as text, images, audio, video, links, webpages, minutia (e.g., indicia provided from a client device such as emotion indicators, status text snippets, location indictors, etc.), or other multi-media. In various implementations, content items can be social network items or parts of social network items, such as posts, likes, mentions, news items, events, shares, comments, messages, other notifications, etc. Subjects and concepts, in the context of a social graph, comprise nodes that represent any person, place, thing, or idea.

A social networking system can enable a user to enter and display information related to the user's interests, age/date of birth, location (e.g., longitude/latitude, country, region, city, etc.), education information, life stage, relationship status, name, a model of devices typically used, languages identified as ones the user is facile with, occupation, contact information, or other demographic or biographical information in the user's profile. Any such information can be represented, in various implementations, by a node or edge between nodes in the social graph. A social networking system can enable a user to upload or create pictures, videos, documents, songs, or other content items, and can enable a user to create and schedule events. Content items can be represented, in various implementations, by a node or edge between nodes in the social graph.

A social networking system can enable a user to perform uploads or create content items, interact with content items or other users, express an interest or opinion, or perform other actions. A social networking system can provide various means to interact with non-user objects within the social networking system. Actions can be represented, in various implementations, by a node or edge between nodes in the social graph. For example, a user can form or join groups, or become a fan of a page or entity within the social networking system. In addition, a user can create, download, view, upload, link to, tag, edit, or play a social networking system object. A user can interact with social networking system objects outside of the context of the social networking system. For example, an article on a news web site might have a “like” button that users can click. In each of these instances, the interaction between the user and the object can be represented by an edge in the social graph connecting the node of the user to the node of the object. As another example, a user can use location detection functionality (such as a GPS receiver on a mobile device) to “check in” to a particular location, and an edge can connect the user's node with the location's node in the social graph.

A social networking system can provide a variety of communication channels to users. For example, a social networking system can enable a user to email, instant message, or text/SMS message, one or more other users. It can enable a user to post a message to the user's wall or profile or another user's wall or profile. It can enable a user to post a message to a group or a fan page. It can enable a user to comment on an image, wall post or other content item created or uploaded by the user or another user. And it can allow users to interact (via their personalized avatar) with objects or other avatars in an artificial reality environment, etc. In some embodiments, a user can post a status message to the user's profile indicating a current event, state of mind, thought, feeling, activity, or any other present-time relevant communication. A social networking system can enable users to communicate both within, and external to, the social networking system. For example, a first user can send a second user a message within the social networking system, an email through the social networking system, an email external to but originating from the social networking system, an instant message within the social networking system, an instant message external to but originating from the social networking system, provide voice or video messaging between users, or provide an artificial reality environment were users can communicate and interact via avatars or other digital representations of themselves. Further, a first user can comment on the profile page of a second user, or can comment on objects associated with a second user, e.g., content items uploaded by the second user.

Social networking systems enable users to associate themselves and establish connections with other users of the social networking system. When two users (e.g., social graph nodes) explicitly establish a social connection in the social networking system, they become “friends” (or, “connections”) within the context of the social networking system. For example, a friend request from a “John Doe” to a “Jane Smith,” which is accepted by “Jane Smith,” is a social connection. The social connection can be an edge in the social graph. Being friends or being within a threshold number of friend edges on the social graph can allow users access to more information about each other than would otherwise be available to unconnected users. For example, being friends can allow a user to view another user's profile, to see another user's friends, or to view pictures of another user. Likewise, becoming friends within a social networking system can allow a user greater access to communicate with another user, e.g., by email (internal and external to the social networking system), instant message, text message, phone, or any other communicative interface. Being friends can allow a user access to view, comment on, download, endorse or otherwise interact with another user's uploaded content items. Establishing connections, accessing user information, communicating, and interacting within the context of the social networking system can be represented by an edge between the nodes representing two social networking system users.

In addition to explicitly establishing a connection in the social networking system, users with common characteristics can be considered connected (such as a soft or implicit connection) for the purposes of determining social context for use in determining the topic of communications. In some embodiments, users who belong to a common network are considered connected. For example, users who attend a common school, work for a common company, or belong to a common social networking system group can be considered connected. In some embodiments, users with common biographical characteristics are considered connected. For example, the geographic region users were born in or live in, the age of users, the gender of users and the relationship status of users can be used to determine whether users are connected. In some embodiments, users with common interests are considered connected. For example, users' movie preferences, music preferences, political views, religious views, or any other interest can be used to determine whether users are connected. In some embodiments, users who have taken a common action within the social networking system are considered connected. For example, users who endorse or recommend a common object, who comment on a common content item, or who RSVP to a common event can be considered connected. A social networking system can utilize a social graph to determine users who are connected with or are similar to a particular user in order to determine or evaluate the social context between the users. The social networking system can utilize such social context and common attributes to facilitate content distribution systems and content caching systems to predictably select content items for caching in cache appliances associated with specific social network accounts.

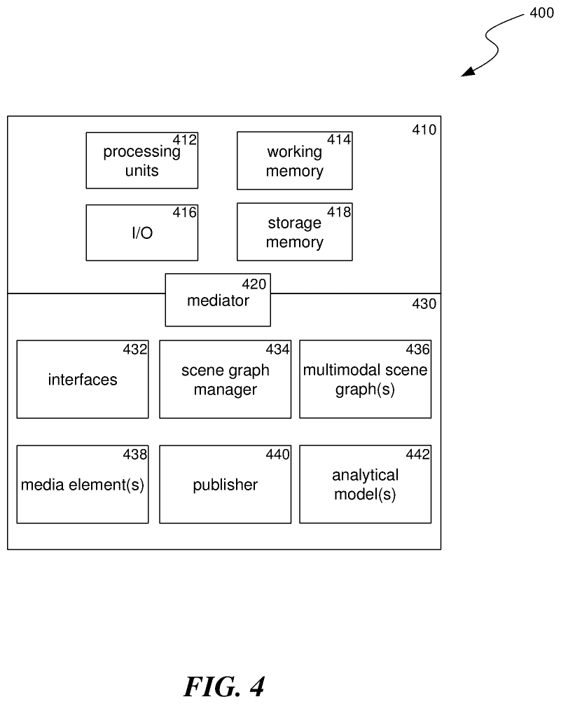

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for generating media element(s) using a multimodal scene graph. Specialized components 430 can include scene graph manager 434, multimodal scene graph(s) 436, media element(s) 438, and publisher 440, analytical model(s) 442, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

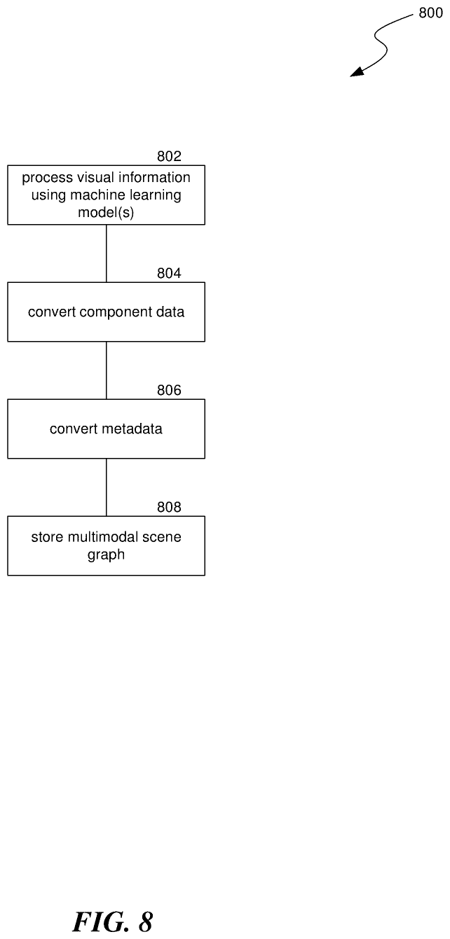

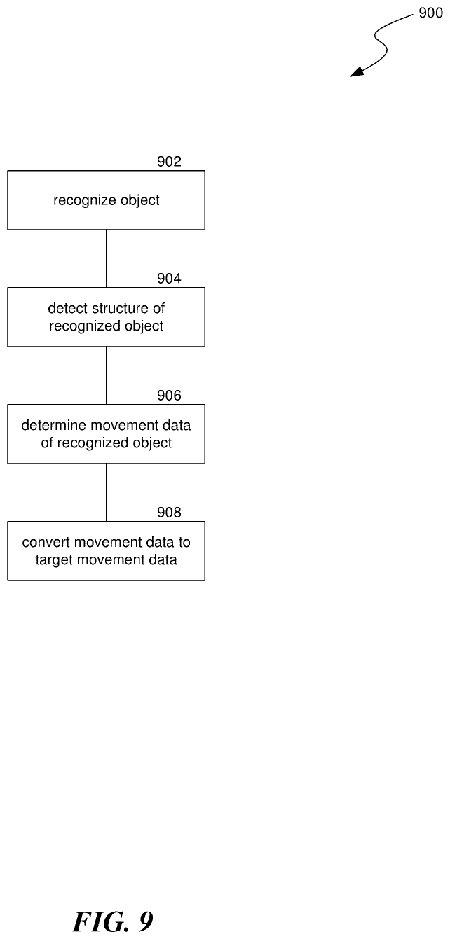

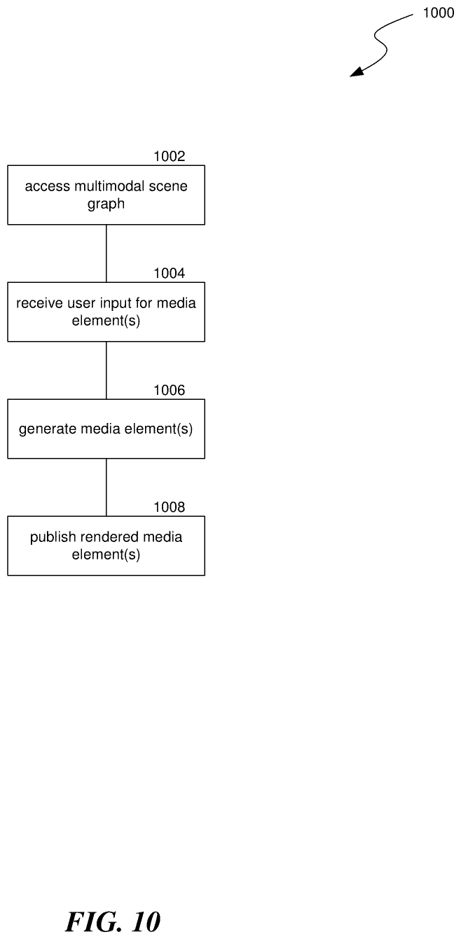

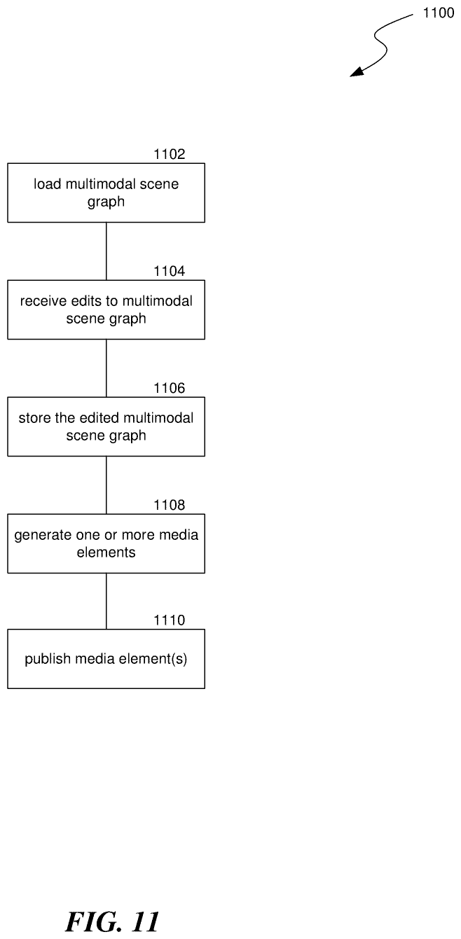

Scene graph manager 434 can generate multimodal scene graphs from visual information and render media elements using the generated multimodal scene graphs. For example, scene graph manager 434 can process underlying visual information (e.g., images, video, XR scenes, etc.) and convert the visual information into Multimodal scene graph(s) 436. Multimodal scene graph(s) 436 can represent objects (which can include people) and metadata within the underlying visual information. Scene graph manager 434 can render, using multimodal scene graph(s) 436, media element(s) 440, such as images, video, an XR scene, and the like. Additional details on scene graph manager 434 are provided below in relation to blocks 802-808 of FIG. 8, blocks 902-908 of FIG. 9, blocks 1002-1006 of FIG. 10, and blocks 1102-1108 of FIG. 11.

Multimodal scene graph(s) 436 are scene graphs that store component data and metadata converted from visual information, such as images, video, XR scenes, and the like. For example, component data can include component structure, movement data, component location, and the like. Metadata can include a background, audio, three-dimensional environment, and the like. Multimodal scene graph(s) 436 can be a serialized representation of the underlying visual information conducive for sharing and editing. Additional details on multimodal scene graph(s) 436 are provided below in relation to blocks 802-808 of FIG. 8, blocks 902-908 of FIG. 9, blocks 1002-1006 of FIG. 10, and blocks 1102-1108 of FIG. 11.

Media element(s) 438 can be image, video, XR scenes, or any other suitable media. For example, media element(s) 438 can be generated using multimodal scene graph(s) 436. Media element(s) 438 can be two-dimensional media (e.g., images or video) or three-dimensional media (e.g., images, video, XR scenes). In some implementations, variations of media element(s) 438 can be generated from a given one of multimodal scene graph(s) 436 and/or variations of media element(s) 438 can be generated from an edited one of multimodal scene graph(s) 436. Additional details on media element(s) 438 are provided below in relation to block 908 of FIG. 9, blocks 1004-1008 of FIG. 10, and blocks 1108-1110 of FIG. 11.

Publisher 440 can publish media element(s) for viewing and access by social users. For example, publisher 440 can publish media element(s) 438 to a social platform. Social platform users can view the published media element(s) 438. In some implementations, social platform users can access multimodal scene graph(s) 436 associated with published media element(s) 438 to edit the scene graph(s). For example, additional media element(s) 438 can be rendered using the edited multimodal scene graph(s) 436, and publisher 440 can then publish these additional media element(s) 438. Additional details on publisher 440 are provided below in relation to block 1008 of FIG. 10 and block 1110 of FIG. 11.

Analytical resource(s) 442 can be trained machine learning model(s) configured to perform a workload on visual information, various 2D or 3D models, kinematic models, mapping or location data (e.g., SLAM data), and the like. Example analytical resource(s) 442 can be: a) one or more trained machine learning models configured to process visual information (e.g., video) to recognize object(s), detect object structure, and estimate object movement; b) one or more trained machine learning models configured to convert object movement data into avatar movement data and render an animated avatar; c) one or more generative machine learning models configured to generate captions, images, and/or video using input data such as visual information, text, audio, and/or commands (e.g., prompts); d) and any other suitable machine learning models. For example, analytical resource(s) 442 can include convolutional neural networks, deep convolutional neural networks, very deep convolutional neural networks, transformer networks, encoders and decoders, generative adversarial networks (GANS), large language models, neural networks, support vector machines, Parzen windows, Bayes, clustering models, reinforcement models, probability distributions, decision trees, decision tree forests, and other suitable machine learning components.

A “machine learning model,” as used herein, refers to a construct that is configured (e.g., trained using training data) to make predictions, provide probabilities, augment data, and/or generate data. For example, training data for supervised learning can include items with various parameters and an assigned classification. A new data item can have parameters that a model can use to assign a classification to the new data item. Machine learning models can be configured for various situations, data types, sources, and output formats.

In some implementations, a machine learning model can include one or more neural networks, each with multiple input nodes that receive input data (e.g., visual information, audio, text, etc.). The input nodes can correspond to functions that receive the input and produce results. These results can be provided to one or more levels of intermediate nodes that each produce further results based on a combination of lower level node results. A weighting factor can be applied to the output of each node before the result is passed to the next layer node. At a final layer, (“the output layer”) one or more nodes can produce an output that, once the model is trained, represents a modified version of the input and/or an output generated via the input. In some implementations, such neural networks, known as deep neural networks, can have multiple layers of intermediate nodes with different configurations, can be a combination of models that receive different parts of the input and/or input from other parts of the deep neural network, and/or can be a recumbent model (partially using output from previous iterations of applying the model as further input to produce results for the current input).

In some implementations, machine learning models can be trained using data captured by one or more XR systems. For example, XR systems can capture, via cameras, movement data of a user and cause movement of the user's avatar. The captured visual information and avatar movement can be processed to create training data for one or more machine learning models. For example, the machine learning model(s) can be trained to estimate avatar movement in response to movement of a person in a video/XR scene, and/or sensed movement by the person via one or more sensors (e.g., cameras, etc.).

In some implementations, one or more generative machine learning models can comprise large language models trained to generate visual information using input, such as images, video, prompts, and the like. For example, the generative machine learning model(s) can be trained to fit two avatars into an image or video that previously included a single avatar, for example by resizing the avatars. The generative machine learning model(s) can also be trained to replace the background of an image or video with an alternative background. The generative machine learning model(s) can also be trained to flatten three-dimensional visual data (e.g., background, visual objects, etc.) into two-dimensional visual data. For example, training instances that comprise three-dimensional visual depictions of objects and two-dimensional visual depictions of objects can train the generative machine learning model(s) to flatten objects.

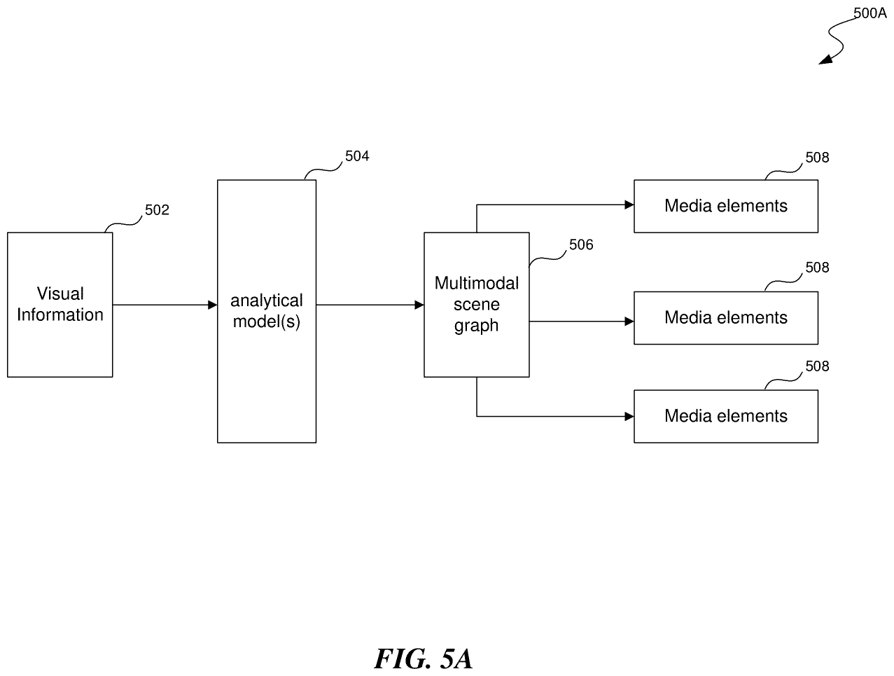

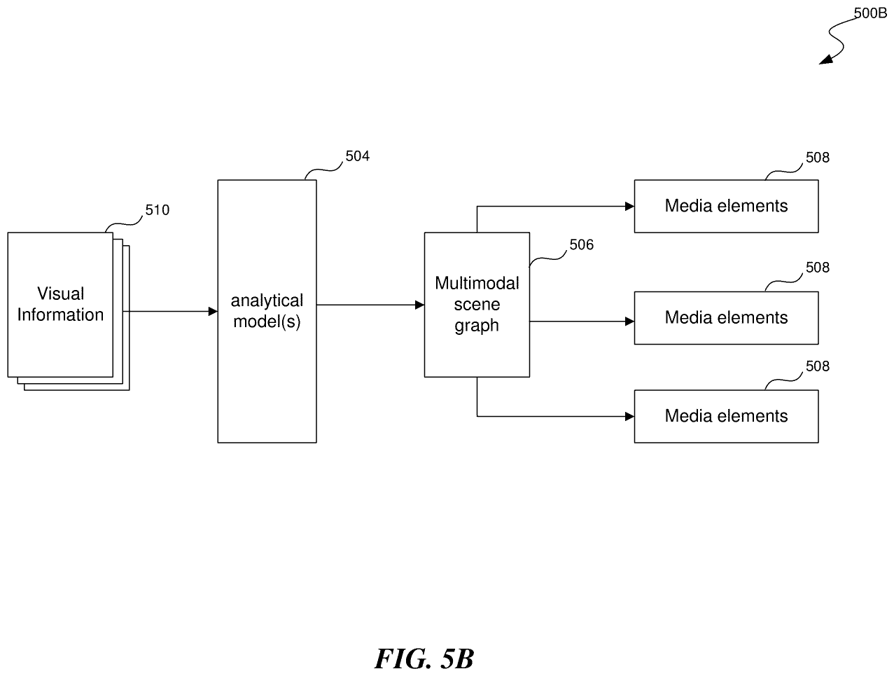

Implementations of multimodal scene graph(s) support variation and social interactions using media elements, such as images, video, and/or XR scenes. FIG. 5A is a conceptual diagram 500A illustrating a multimodal scene graph and rendered media element(s). Diagram 500A includes visual information 502, analytical model(s) 504, multimodal scene graph 506, and media elements 508.

Visual information 502 can comprise an image, video, XR scene, two-dimensional visual information, three-dimensional visual information, and the like. Analytical model(s) 504 can process visual information 502 to generate multimodal scene graph 506. For example, analytical model(s) 504 can recognize objects in visual information 502 and convert visual information 502 into component data for multimodal scene graph 506 with respect to the recognized objects. The component data can include structural data (e.g., representative of a structure of the object), location data (e.g., representative of the object's location with respect to visual information 502), and movement data (e.g., representative of detected movement of the object). Recognized objects can include people, animals, furniture, virtual objects (e.g., in an XR scene), text/captions, or any other suitable real-world or virtual objects. Accordingly, multimodal scene graph 506 can include component data for each object recognized in visual information 502. Analytical model(s) 504 can also recognize context of visual information 502, such as visual context (e.g., background, three-dimensional environment, etc.) and/or other context (e.g., audio). For example, analytical model(s) 504 can convert the recognized context into metadata for multimodal scene graph 506. Example metadata can include a background, three-dimensional environment, audio, and the like.

Media elements 508 can be generated using multimodal scene graph 506. For example, multimodal scene graph 506 can represent a serialized structure that stores one or more renderable elements within media elements 508, including objects, a background, audio, and the like. In some implementations, user selections define variations for media elements 508. For example, a first and second of media elements 508 can include a visual object that corresponds to a person captured in visual information 502, such as an avatar for the person. The first of media elements 508 can be an image that displays the avatar in a first pose while the second of media elements 508 can be an image that displays the avatar in a second pose. For example, a user may select a first point in time with respect to visual information 502 (e.g., a video, animated image, etc.) for the first of media elements 508 where the person was positioned in the first pose and a second point in time with respect to visual information 502 for the second of media elements 508 where the person was positioned in the second pose. A third of media elements 508 can comprise a video or animated image with animated movement of the avatar. For example, a user may select a duration of time for the third of media elements 508 over which the person's movements correspond to the animated movement of the avatar.

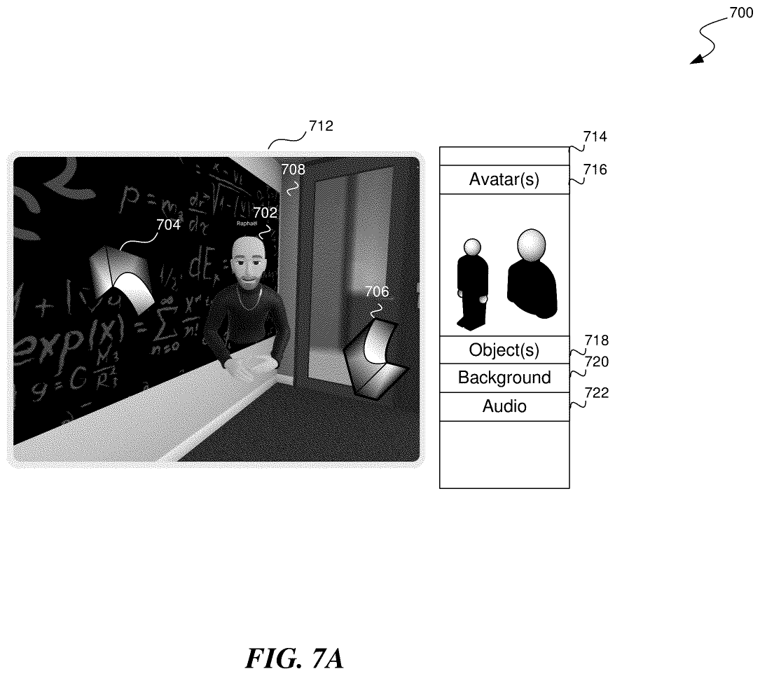

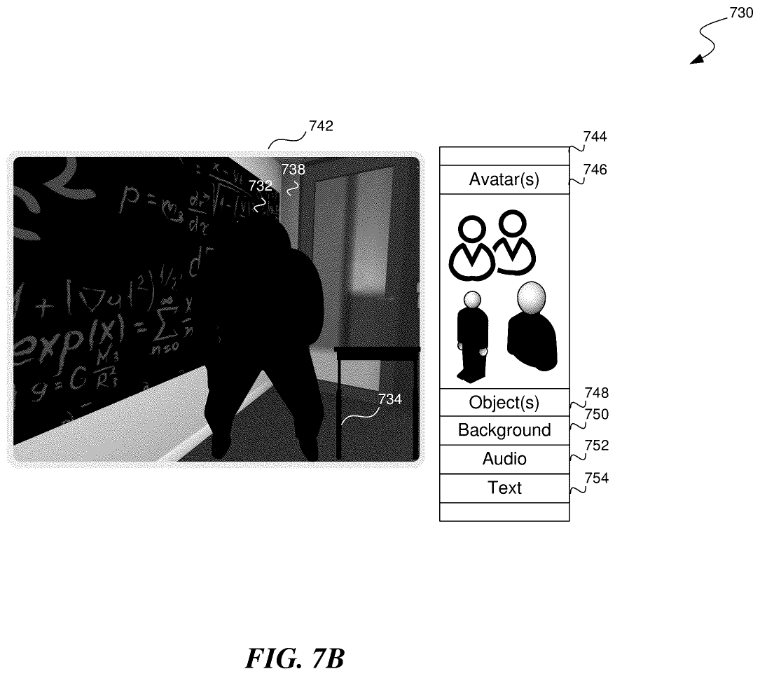

Media elements 508 can be shared via posting to a social media platform, and social platform users can view media elements 508. In some implementations, social platform users may access and edit multimodal scene graph 506. For example, a social platform user may opt to generate a variation similar to one or more of media elements 508, but that comprises some differences. The social platform user can access and generate an edited version of multimodal scene graph 506 and render additional media elements, via selections from the edited multimodal scene graph, that comprise similarities to media elements 508, but that include variations that corresponds to the social platform user's edits and/or selections. FIG. 11 further describes social platform user edits to a multimodal scene graph and the subsequent generation of media elements. In some implementations, a composer tool as illustrated in FIGS. 7A and 7B can be used to perform edits to a multimodal scene graph.

FIG. 5B is a conceptual diagram 500B illustrating a multimodal scene graph converted from multiple underlying instances of visual information. Diagram 500B includes visual information instances 510, analytical model(s) 504, multimodal scene graph 506, and media elements 508. In the illustrated example, multiple instances of visual information 510 can be processed and converted into multimodal scene graph 506. For example, a background from a first of visual information instances 510 can be combined with component data from a second of visual information instances 510 and audio data from a third of visual information instances 510. In this example, media elements 508 generated via multimodal scene 506 can comprise aspects from different ones of visual information 510, such as an avatar of a first user depicted in the second of visual information instances 510, background from the first of visual information instances 510, and caption/text generated from the audio of the third of visual information instances 510.

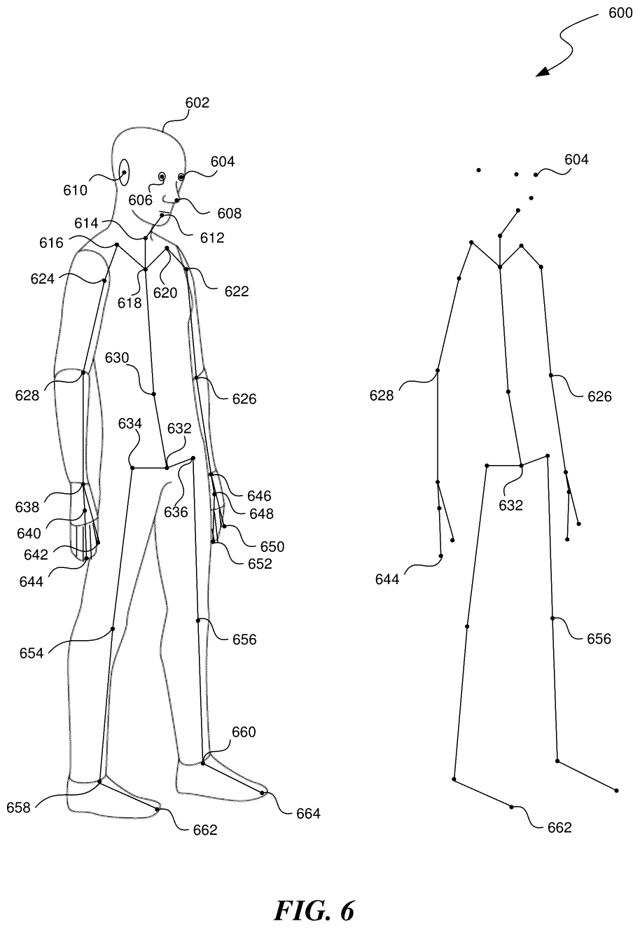

In some implementations, analytical model(s) can detect movement of objects and/or convert object movement into avatar movement. FIG. 6 is a conceptual diagram 600 of a kinematic model for a detected object. Diagram 600 comprises a mapping of a kinematic model onto a depiction of a person. On the left side, diagram 600 illustrates points defined on a body of a user 602 while these points are again shown on the right side of diagram 600 without the corresponding person to illustrate the actual components of a kinematic model. These points include eyes 604 and 606, nose 608, ears 610 (second ear point not shown), chin 612, neck 614, clavicles 616 and 620, sternum 618, shoulders 622 and 624, elbows 626 and 628, stomach 630, pelvis 632, hips 634 and 636, wrists 638 and 646, palms 640 and 648, thumb tips 642 and 650, fingertips 644 and 652, knees 654 and 656, ankles 658 and 660, and tips of feet 662 and 664. In various implementations, more or less points are used in a kinematic model (e.g., additional points on a user's face can be mapped to determine more fine-grained facial expressions). Some corresponding labels have been put on the points on the right side of FIG. 6, but some have been omitted to maintain clarity. Points connected by lines show that the kinematic model maintains measurements of distances and angles between certain points. Because points 604-610 are generally fixed relative to point 612, they do not need additional connections.

In some implementations, points of a kinematic model can comprise joints, such as elbows, knees, wrists, finger joints, etc. Movement of a kinematic model can be represented, in part, as rotation information (e.g., rotational matrices) with respect to moveable joints of the kinematic model. For example, tracked user movements can be transposed onto three-dimensional structures, such as a kinematic model, via positional and/or rotational information with respect to the points/joints of the kinematic model. In some implementations, component movement data generated in response to movement of a recognized object comprises positional and/or rotational information relative to the points of a kinematic model. For example, component data of a multimodal scene graph can comprise positional and/or rotational information relative to the points of a kinematic model based on user movements detected in underlying visual information (e.g., video, XR scene, etc.). FIG. 9 further describes generating component data for a multimodal scene graph and converting detected movement data into target movement data (e.g., movement data relative to the structure of an avatar).

In some implementations, a multimodal scene graph can represent an XR scene and/or one or more media elements rendered via a multimodal scene graph can be an XR scene. FIG. 7A is an example 700 tool for interacting with an artificial reality scene related to a multimodal scene graph. XR scene 712 includes avatar 702, virtual objects 704 and 706, and background 708. In some implementations, XR scene 712 can be loaded from the component data and metadata of a stored multimodal scene graph. In some implementations, a XR scene recorder can record XR scene 712 from a XR environment displayed to a user. In some implementations, one or more of avatar 702, virtual object 704, virtual object 706, or any combination thereof can comprise animation data (e.g., avatar motion dynamics, virtual object motion dynamics, etc.).

A XR scene recorder can recognize components of the XR environment as scene components of the XR scene, such as avatar 702, motion dynamics of avatar 702, virtual objects 704, motion dynamics of virtual object 704, virtual objects 706, motion dynamics of virtual object 706, lighting of the XR environment, audio output to the user during the XR environment, and other suitable scene components. In some implementations, XR scene 712 can be generated and/or edited using a scene composer tool. For example, a scene composer tool can load a recorded XR environment for editing, load an XR environment associated with an accessed multimodal scene graph, and/or generate an XR scene without a loaded or recorded XR scene (e.g., from scratch). U.S. patent application Ser. No. 18/069,240, (Attorney Docket No. 3589-0180US01) titled “Artificial Reality Scene Composer,” filed Dec. 21, 2022, which is herein incorporated by reference in its entirety, further describes techniques for recognizing scene components from a recorded XR scene. In some implementations, XR scene 712 is edited via scene composer tool, and the edited scene is stored as a new or edited multimodal scene graph.

A scene composer tool can comprise XR scene 712 and tool 714. For example, tool 714 can be a set of elements shared from scenes created by others and shared to a cloud-based library. In some implementations, tool 714 can be populated by components loaded from one or more multimodal scene graphs. For example, XR scene 712 can correspond to a first multimodal scene graph, and components of tool 712 (e.g., avatars, virtual objects, background, audio, etc.) can be loaded from one or more second multimodal scene graphs, such as scene graphs published and accessed via a social platform. In this example, scene components can be added to XR scene 712 that are generated from different underlying visual information (e.g., different XR scenes, video, and/or images can be used to create multimodal scene graphs whose component data and/or metadata is used to populate tool 714 with scene components).

In some implementations, XR scene 712 can be generated without a XR environment recording using tool 714. In some implementations, tool 714 is used to edit an existing XR scene 712, such as an XR scene that corresponds to a multimodal scene graph that is under edit. Tool 714 comprises avatar element 716, virtual object element 718, background element 720, and audio element 722. Avatar element 716 can comprise predefined avatar model(s) that can be included in and/or added to XR scene 712. For example, avatar 702 may be included in XR scene 712 via avatar element 716. Predefined avatars can include avatar(s) predefined for a given user (or set of users), default avatar(s), avatar(s) that correspond to a given set (e.g., avatars from a gaming application, movie, etc.), avatars loaded via an accessed multimodal scene graph, or any other suitable predefined avatars. In some implementations, a user interaction with a scene composer tool can be a drag-and-drop interaction where the user selects a predefined avatar from avatar element 716, drags the selected avatar to position it within XR scene 712 (e.g., two-dimensional positioning, three-dimensional positioning, etc.), and drops the selected avatar at the position. Any other suitable user interaction can add predefined avatar(s) from avatar element 716 to XR scene 712.

Virtual object element 718 can be similar to avatar element 716, however virtual object element 718 may include predefined virtual objects. Predefined virtual objects can include virtual object(s) predefined by a user, default virtual object(s), virtual object(s) that correspond to a given set (e.g., virtual objects from a gaming application, movie, etc.), virtual objects loaded via an accessed multimodal scene graph, or any other suitable predefined virtual objects. In some implementations, a user interaction with a scene composer tool can be a drag-and-drop interaction where the user selects a predefined virtual object from virtual object element 718, drags the selected virtual object to position it within XR scene 712, and drops the selected virtual object at the position or onto another element (e.g., applying a predefined motion profile to an avatar already added to the scene). The predefined virtual objects can comprise two-dimensional structures or three-dimensional structural models. Any other suitable user interaction can add predefined virtual object(s) from virtual object element 718 to XR scene 712.

Background element 720 can provide a background component for XR scene 712. For example, a user can select background 708 for XR scene 712 from one or more predefined backgrounds of background element 720. The predefined backgrounds can include user defined background(s) (e.g., backgrounds uploaded to a scene composer tool by a user, backgrounds designed by a user, etc.), default background(s), background(s) that correspond to a given set (e.g., backgrounds from a gaming application, movie, etc.), backgrounds loaded via an accessed multimodal scene graph, or any other suitable predefined backgrounds. Predefined backgrounds can be two-dimensional (e.g., images), three-dimensional (e.g., 3D images/models), include animations (e.g., animated images/models), or be any other suitable background. A user can select a predefined background from background element 720 to add background 708 to XR scene 712 or substitute an existing background of XR scene 712.

Audio element 722 can provide an audio component for XR scene 712. For example, a user can select audio for XR scene 712 from one or more predefined audio recordings of audio element 722. The predefined audio can include user defined audio (e.g., audio uploaded to a scene composer tool by a user, audio recorded by a user, etc.), default audio, audio that correspond to a given set (e.g., audio from a gaming application, movie, etc.), audio loaded via an accessed multimodal scene graph, or any other suitable predefined audio. A user can select audio from audio element 722 to add audio to XR scene 712 or substitute existing audio of XR scene 712. Implementations of audio element 722 can include a recording element to record live audio via a client device operated by the user (e.g., XR system, laptop, smartphone, etc.). For example, one or more microphones of the user's client device can be configured to capture live audio, and audio element 722 can add/substitute the live audio to XR scene 712.

In some implementations, a scene composer tool can define avatar motion dynamics for avatar 702. Avatar motion dynamics can include avatar poses over time, avatar facial expressions over time, or any other suitable motion dynamics. A user can generate avatar motion dynamics via a scene composer tool by selecting avatar 702 and manipulating the avatar with movements over time. Implementations of a scene composer tool can comprise a motion dynamics recording element that records the movements of avatar 702 caused by the user manipulations. In another example, a client device operated by the user (e.g., XR system, laptop, etc.) can capture user motion/movements via one or more cameras, and a scene composer tool can translate the captured user motion into avatar movement. For example, one or more machine learning models (e.g., computer vision models) can isolate the user from background in the captured images of a user, detect the isolated user's motion, movements, facial expressions, etc., and translate these detected user motion, movements, and facial expressions to avatar motion dynamics (e.g., avatar poses, avatar facial expressions, avatar movements such as walking, dancing, running, singing, etc.).

In another example, a scene composer tool can provide predefined avatar motion dynamics (e.g., avatar waving, smiling, running, dancing, etc.) and the user can select one or a sequence of predefined avatar motion dynamics for avatar 702. For example, predefined motion dynamics can include individual dance moves for an avatar, and the user can select a sequence of the individual dance moves to generate a dance sequence for avatar 702. In some implementations, XR scene 712 is based on a recorded XR environment display, and motion dynamics for avatar 702 can be part of the recorded XR environment display. In some implementations, motions dynamics for avatar 702 can be loaded via an accessed multimodal scene graph.

In some implementations, a scene composer tool can include an effects element that supports user addition and/or editing of XR effects to a XR scene. XR effects can include animations, sound effects, visual effects (e.g., blurring, light effects, etc.), filters, and any other suitable effects. In some implementations, XR effects can be added, substituted, and/or deleted in relation to other components of the XR scene, such as avatars and/or virtual objects. For example, a visual effect overlaid over an avatar can be edited, substituted, or deleted.

In some implementations, a scene composer tool can include a lighting element that supports user adjustment and/or edits to the lighting of an XR scene. For example, a user can adjust (e.g., increase or decrease) the light of an XR scene. In some implementations, the user can select/define a region or volume of the XR scene and adjust the lighting for this individual region or volume.

Implementations of a scene composer tool can generate XR scene 712 from scratch, load a XR scene from a multimodal scene graph, and/or load a recorded XR environment as a XR scene. XR Scene 712 can be generated/edited using avatar element 716, virtual object element 718, background element 720, and/or audio element 722. For example, avatar(s), virtual object(s), background(s), audio, and/or motion dynamics can be added to XR scene 712 or existing components of XR scene 712 (e.g., existing avatar(s), virtual object(s), background(s), audio, and/or motion dynamics) can be substituted.

When an XR scene is loaded from a multimodal scene graph under edit, a scene composer tool provides replacements, substitutes, and/or additions for the components of the multimodal scene graph. For example, substitute avatar(s), virtual object(s), background(s), audio, and/or motion dynamics can create an edited multimodal scene graph that is then stored. This edited multimodal scene graph can go through several iterations of edits via different users. The several iterations of edits create several different versions of a multimodal scene graph that can share common threads, such as avatar movements, background, audio, virtual objects, etc. In some implementations, the users that perform these edits are connected via a social platform. Accordingly, the several different versions can serve as a mechanism for social interaction among the users.

In some implementations, a user, a via scene composer tool, can remove or delete components from XR scene 712 (e.g., a recorded scene, stored scene, etc.). For example, once loaded, components of XR scene 712, such as avatar(s), virtual object(s), background, audio, motion dynamic(s), etc., can be selected and deleted. User selection/deletion can occur via the individual scene components displayed by XR scene 712 (e.g., cursors based selection and deletion), scene components listed by elements of tool 714 (e.g., avatar element 716, virtual object element 718, background element 670, and audio element 722), or any other suitable technique.

In some implementations, the created and/or edited XR Scene 712 is converted into a multimodal scene graph (e.g., stored as component data and metadata). The multimodal scene graph can represent an XR scene that comprises a three-dimensional display (e.g., three-dimensional model with avatar/object movement, audio, etc.), two-dimensional display (e.g., animated image, video, audio, etc.), or any other suitable display. In some implementations, the multimodal scene graph can support rendering media elements, such as an XR scene, image, and/or video using the component data and metadata. Images and/or video rendered via the multimodal scene graph can be generated from a perspective with respect to the XR scene represented. For example, a user can navigate through the loaded XR scene (e.g., via interactions with a scene composer tool) and select a perspective from which to render image and/or video media elements. In some implementations, the media rendered from the multimodal scene graph can be an abbreviated XR scene, such as an XR scene with select components from the multimodal scene graph. For example, the user can select a subset of the scene components represented by the component data and metadata of the multimodal scene graph (e.g., an avatar, background, and a single virtual object), and the rendered media can comprise an XR scene limited to these selected components.

In some implementations, a user can interact with a scene composer tool to render media element(s) via a loaded multimodal scene graph. For example, the user can select components of the loaded multimodal scene graph, metadata of the multimodal scene graph, a camera view (e.g. perspective) of the loaded XR scene, a point in time with respect to XR scene animation for the media elements (e.g., span of time and/or individual point in time), a point in time with respect to XR scene audio for the media elements (e.g., span of time and/or individual point in time), and the like. The user can also select a media type for rendering, such as image, video, three-dimensional image, three-dimensional video, two-dimensional image, two-dimensional video, image sticker (e.g., flat image comprising a predefined style), an abbreviated XR scene, and the like. Via different user selections, different variations of media elements can be rendered, such as: a) images of different scene components, from different perspectives, and/or at different points in time with respect to the XR scene animation and/or audio; b) videos of different scene components, from different perspectives, and/or at different points in time with respect to the XR scene animation and/or audio, and c) abbreviated XR scenes comprising different scene components and/or at different points in time with respect to the XR scene animation and/or audio. Any suitable variations of rendered media elements can be published and shared via a social platform. In some implementations, social platform users can view the published media element(s), access the multimodal scene graph used to render the media element(s), edit the multimodal scene graph via a composer tool, and generate additional variations of media element(s) via additional user selections.

FIG. 7B is an example tool for interacting with an image or video related to a multimodal scene graph. Similar to the example 700 with a scene composer tool of FIG. 7A, example 730 illustrates a composer tool of FIG. 7B which can be used to edit a loaded multimodal scene graph. For example, visual information 742 can be an image or video associated with the component data and metadata of a loaded multimodal scene graph. In some implementations, visual information 742 comprises the underlying visual information (e.g., image, video, etc.) that was converted to generate the multimodal scene graph. In some implementations, visual information 742 comprises one or more media element(s) (e.g., images and/or videos) rendered using the multimodal scene graph. Visual information 742 can be any other suitable visual display that illustrates the components and metadata of a multimodal scene graph.

In the illustrated example, visual information 742 can comprise person 732, object 734, and background 738. For example, these components of visual information 742 can represent the component data and metadata of the loaded multimodal scene graph. Tool 744 comprises avatar element 746, object element 748, background element 750, audio element 752, and text element 754. Avatar element 746 can comprise predefined avatar model(s) that can be included in and/or added to the loaded multimodal scene graph. Predefined avatars can include avatar(s) predefined for a given user (or set of users), default avatar(s), avatar(s) that correspond to a given set (e.g., avatars from a gaming application, movie, etc.), avatars loaded via an accessed multimodal scene graph, or any other suitable predefined avatars. In some implementations, a user interaction with a scene composer tool can be a drag-and-drop interaction where the user selects a predefined avatar from avatar element 746, drags the selected avatar to position it within visual information 742, and drops the selected avatar at the position. In some implementations, user interactions can replace person 732 with an avatar representation of the person. Any other suitable user interaction can add predefined avatar(s) from avatar element 746 to visual information 742.

Object element 748 can be similar to avatar element 746, however object element 748 may include predefined objects. Predefined objects can include object(s) predefined by a user, default object(s), object(s) that correspond to a given set (e.g., virtual objects from a gaming application, movie, etc.), objects loaded via an accessed multimodal scene graph, or any other suitable predefined objects. In some implementations, a user interaction with a scene composer tool can be a drag-and-drop interaction where the user selects a predefined object from object element 748, drags the selected object to position it within visual information 742, and drops the selected object at the position. Any other suitable user interaction can add predefined object(s) from object element 748 to visual information 742.

Background element 750 can be used to provide and/or edit a background component for a loaded multimodal scene graph. For example, a user can replace background 738 for visual information 742 using one or more predefined backgrounds of background element 750. The predefined backgrounds can include user defined background(s) (e.g., backgrounds uploaded to a scene composer tool by a user, backgrounds designed by a user, etc.), default background(s), background(s) that correspond to a given set (e.g., backgrounds from a gaming application, movie, etc.), backgrounds loaded via an accessed multimodal scene graph, or any other suitable predefined backgrounds. Predefined backgrounds can be two-dimensional (e.g., images), three-dimensional (e.g., 3D images/models), include animations (e.g., animated images/models), or be any other suitable background.

Audio element 752 can replace or provide an audio component for a loaded multimodal scene graph. For example, a user can select audio for the loaded multimodal scene graph from one or more predefined audio recordings of audio element 752. The predefined audio can include user defined audio (e.g., audio uploaded to a scene composer tool by a user, audio recorded by a user, etc.), default audio, audio that correspond to a given set (e.g., audio from a gaming application, movie, etc.), audio loaded via an accessed multimodal scene graph, or any other suitable predefined audio. A user can select audio from audio element 752 to add audio to the loaded multimodal scene graph or substitute existing audio of the loaded multimodal scene graph. Implementations of audio element 752 can include a recording element to record live audio via a client device operated by the user (e.g., XR system, laptop, smartphone, etc.). For example, one or more microphones of the user's client device can be configured to capture live audio, and audio element 752 can add/substitute the live audio to the loaded multimodal scene graph.

Text element 754 can replace or provide text for a loaded multimodal scene graph, such as a caption for an image and/or video. In some implementations, existing text and/or captions for a loaded multimodal scene graph can be generated based on audio from a video that was converted into the multimodal scene graph. Text element 754 can be used to edit existing text/captions or add text/captions to a loaded multimodal scene graph.

In some implementations, a scene composer tool can include an effects element that supports user addition and/or editing of effects to the loaded multimodal scene graph. Effects can include animations, sound effects, visual effects (e.g., blurring, light effects, etc.), filters, and any other suitable effects. In some implementations, effects can be added, substituted, and/or deleted in relation to other components of the loaded multimodal scene graph, such as avatars and/or objects. For example, a visual effect overlaid over an avatar can be edited, substituted, or deleted.

In some implementations, a scene composer tool provides replacements, substitutes, and/or additions for the components and/or metadata of a loaded multimodal scene graph. For example, substitute avatar(s), object(s), background(s), audio, and/or text/captions can create an edited multimodal scene graph that is then stored. This edited multimodal scene graph can then go through several iterations of edits via different users. The several iterations of edits create several different versions of a multimodal scene graph that can share common threads, such as avatar movements, background, audio, objects, etc. In some implementations, the users that perform these edits are connected via a social platform. Accordingly, the several different versions can serve as a mechanism for social interaction among the users.

In some implementations, a user, via a scene composer tool, can remove or delete components from the loaded multimodal scene. For example, once loaded, components and/or metadata, such as avatar(s), object(s), background, audio, text/captions, etc., can be selected and deleted. User selection/deletion can occur via the individual scene components displayed by visual information 742 (e.g., cursors based selection and deletion), components/metadata listed by elements of tool 744, or any other suitable technique.

In some implementations, the edited multimodal scene graph is stored as component data and metadata. The edited multimodal scene graph can support rendering media elements, such as images and/or video using the component data and metadata. In some implementations, a user can interact with a scene composer tool to render media element(s) via the edited multimodal scene graph. For example, the user can select components of the multimodal scene graph, metadata of the multimodal scene graph, a point in time with respect to video and/or an animated image (e.g., span of time and/or individual point in time), a point in time with respect audio (e.g., span of time and/or individual point in time), and the like. The user can also select a media type for rendering, such as image, video, three-dimensional image, three-dimensional video, two-dimensional image, two-dimensional video, image sticker (e.g., flat image comprising a predefined style), and the like. Via different user selections, different variations of media elements can be rendered, such as: images of different components, from different perspectives, and/or at different points in time with respect to animation and/or audio; and videos of different components, from different perspectives, and/or at different points in time with respect to animation and/or audio. Any suitable variations of rendered media elements can be published and shared via a social platform. In some implementations, social platform users can view the published media element(s), access the multimodal scene graph used to render the media element(s), edit the multimodal scene graph via a composer tool, and generate additional variations of media element(s) via additional selections.

In some implementation, editing a multimodal scene graph includes editing select portions of component data. For example, a multimodal scene graph can include component data for an avatar. Editing the multimodal scene graph can include replacing individual parts of the avatar, such as the avatar's head, lower body, upper body arms, etc. In some implementations, the movement data associated with individual parts of an avatar component can also be replaced. In an example, a composite avatar of a multimodal scene graph, after a series of edits, can include: an upper body from a first predefined avatar, a lower body from a second predefined avatar, a head from a third predefined avatar, movement data for the avatar's arms that corresponds to first dance choreography, and movement data for the avatar's legs that corresponds to second dance choreography.

Those skilled in the art will appreciate that the components illustrated in FIGS. 1-4, 5A, 5B, 6, 7A, and 7B described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 8 is a flow diagram illustrating a process 800 used in some implementations of the present technology for converting visual information into a multimodal scene graph. Process 800 can be performed at a XR system, cloud system, edge system, mobile device, smart home device, laptop, desktop, server, any other suitable computing device, or any combination thereof. Process 800 can be triggered by user interactions related to storing a multimodal scene graph, such as capturing a video, taking a picture, loading an image, video, and/or an XR scene, and the like.

At block 802, process 800 can process visual information using analytical model(s). For example, visual information can comprise an image, video, XR scene, two-dimensional visual information, three-dimensional visual information, and the like. Analytical model(s), such as trained machine learning model(s) can process the visual information to recognize objects in the visual information and recognize context (e.g., a background, audio, etc.) of the visual information.

At block 804, process 800 can convert component data. For example, the recognized objects within the visual information can be converted to component data. Example component data includes structural data (e.g., representative of a structure of the object), location data (e.g., representative of the object's location with respect to visual information 502), and movement data (e.g., representative of detected movement of the object). Each object recognized in the visual information can correspond to an instance of component data. Recognized objects can include people, animals, furniture, virtual objects (e.g., in an XR scene), text/captions, or any other suitable real-world or virtual objects. In some implementations, the detected movement data of a recognized object (and corresponding component data for that object) can include a person's facial expressions. FIG. 9 further describes detecting movement data of a person.

At block 806, process 800 can convert metadata. For example, the context of the processed visual information can be converted into metadata. Context includes visual context (e.g., background, three-dimensional environment, etc.) and/or other context (e.g., audio). Example metadata can include a background, three-dimensional environment, audio, and the like.

At block 808, process 800 can store the multimodal scene graph. For example, the component data and metadata can be stored as a multimodal scene graph converted from the visual information. The multimodal scene graph can represent a serialized and sharable representation of an image, video, XR scene, and the like.

FIG. 9 is a flow diagram illustrating a process 900 used in some implementations of the present technology for generating component data for a multimodal scene graph and converting detected movement data into target movement data. Process 900 can be performed at a XR system, cloud system, edge system, mobile device, smart home device, laptop, desktop, server, any other suitable computing device, or any combination thereof. Process 900 can be triggered by user interactions related to storing a multimodal scene graph, such as capturing a video, taking a picture, loading an image, video, and/or an XR scene, and the like.

At block 902, process 900 can recognize object(s) in visual information. For example, the visual information can comprise an image, video, and/or XR scene. One or more machine learning models (e.g., computer vision models) can be trained to recognize objects in visual information. The trained machine learning models can process the visual information to recognize one or more objects.

At block 904, process 900 can detect the structure of recognized object(s). For example, the one or more machine learning models can detect movement of the recognized object(s) and determine a structure for the object(s) based on the movement. In some implementations, a category for the recognized objects can be predicted by the machine learning model(s) (e.g., person, furniture, etc.), and the structure can be detected based on the predicted category. For example, when an object is predicted to be a person, the detected structure can be a kinematic model for a human.

At block 906, process 900 can determine movement data of the recognized object(s). For example, one or more machine learning models can detect movement of the recognized object(s). The movement data can comprise movement with respect to the detected structure of an object, such as positional and/or rotational values. In some implementations, when a detected object is predicted to be a person, the movement data comprises rotational and/or positional values with respect to a kinematic model for a human. In some implementations, machine learning model(s) blend movements over time by interpolating one or more movement data values. In some implementations, determined movement data includes facial expressions and/or blendshapes with respect to a defined facial structure. In some implementations, determined movement data for a given object can be stored as movement data for a component of a multimodal scene graph, such as a component instance that corresponds to the given object.

At block 908, process 900 can convert the object movement data to target movement data. For example, one or more machine learning models can transform the rotational and/or positional values with respect to the detected structure of an object (e.g., kinematic model of a human) such that the transformed rotational and/or positional values are with respect to a defined structure of a target (e.g., skeleton of an avatar). For example, an avatar skeleton can be similar to a kinematic model of a human, yet can comprise one or more differences. In some examples, the skeleton of an avatar is different from a human, for example when the avatar's movements differ from the movements of a human.

In some implementations, the converted object movement data can be stored as movement data for a component of a multimodal scene graph. For example, a person may be replaced by an avatar in a given multimodal scene graph, and in this example, the movement data of with respect to a human (e.g., kinematic model) can similarly be replaced by the movement data with respect to the avatar's skeleton. In some implementations, the machine learning model(s) that convert the movement data of the object to the target movement data can render an avatar using the converted movement data. In some implementations, the rendered avatar can be part of media rendered using a multimodal scene graph. For example, the rendered avatar can be animated according to the converted movement data. In another example, the rendered avatar can be rendered in a given pose that corresponds to a pose of the detected object at a given point in time within the visual information (e.g., pose of a person at a given point in time during a video).

FIG. 10 is a flow diagram illustrating a process 1000 used in some implementations of the present technology for rendering and publishing media element(s) using a multimodal scene graph. Process 1000 can be performed at a XR system, cloud system, edge system, mobile device, smart home device, laptop, desktop, server, any other suitable computing device, or any combination thereof. Process 1000 can be triggered by user interactions related to generating media element(s), such as executing a social related application, media related application, triggering certain functionality of these applications, and the like.

At block 1002, process 1000 can access a multimodal scene graph. For example, a multimodal scene graph comprising component data and metadata can be accessed. As described with reference to FIG. 8, the multimodal scene graph can be a representation of visual information (e.g., converted from an image, video, XR scene, etc.). For example, the multimodal scene graph is stored by converting recorded visual information using one or more trained machine learning models, the recorded visual information comprising one or more of a captured image, a captured video, or immersive data from a recorded artificial reality scene. The multimodal scene graph comprises component data, for one or more objects of the recorded visual information, and metadata.

At block 1004, process 1000 can receive user input for media element(s). For example, media element(s) can be rendered using the accessed multimodal scene graph. The rendered media element(s) can include images, video, an XR scene, and any other suitable media element(s). In some implementations, the user input comprises selections with respect to: the components and/or metadata of the multimodal scene graph for rendering; and/or the media type for the media element(s) (e.g., image, video, XR scene, two-dimensional or three-dimensional, etc.). For example, a subset of the components and/or metadata of the multimodal scene graph can be selected for rendering a given media element.

In some implementations, a point of time can be selected with respect to movement data of a particular component of the multimodal scene graph. The point of time can correspond to a given pose for the particular component, and the rendered media can include a visual object that corresponds to the particular component positioned based on the given pose. For example, the particular component can be a person or avatar, and the visual object can be a posed avatar. In some implementations, a duration time can be selected with respect to movement data of a particular component of the multimodal scene graph. The duration of time can correspond to movement data for the particular component, and the rendered media can include a visual object that corresponds to the particular component that is animated based on the movement data. For example, the particular component can be a person or avatar, and the visual object can be an avatar animated according to movement data for the person or avatar.

In some implementations, the recorded visual information comprises three-dimensional information, and the media element comprises a two-dimensional image or video rendered from a first perspective with respect to the three-dimensional information. For example, the recorded visual information can comprise an XR scene, and the media element can be a two-dimensional image or video rendered from a first perspective with respect to the XR scene.

At block 1006, process 1000 can generate the media element(s). For example, the generated media element(s) can include one or more rendered visual objects that represent at least one of the one or more objects from the recorded visual information. In some implementations, an object from the recorded visual information corresponds to a person, and the rendered media element(s) include a rendered avatar that represents the person. The rendered media element(s) can include image(s), video(s), XR scene(s), and the like. In some implementations, the rendered media elements comprise rendered visual context elements that correspond to metadata from the multimodal scene graph, such as a background, rendered audio, and/or rendered text transcribed from metadata audio.

In some implementations, rendering the media element(s) can include generating an initial version of a media element that comprises one or more rendered visual objects and one or more rendered visual context elements. For example, the one or more rendered visual context elements can be generated using the metadata from the multimodal scene graph. The initial version of the media element can be augmented by a user editor to render the media element. For example, augmenting the initial version of the media element comprises one or more of: replacing at least one of the one or more rendered visual context elements, the at least one replaced visual context element comprising a background; deleting at least one of the one or more rendered visual objects; adding one or more visual objects; adding text or captions; and/or adding one or more visual effects.

In some implementations, an other multimodal scene graph is used to augment the initial version of the media element. For example, an other recorded visual information can be processed, where the other recorded visual information comprises one or more of a captured image, a captured video, or immersive data from a recorded artificial reality scene. An other multimodal scene graph can be stored, via the processing, that comprises component data for one or more objects from the other recorded visual information and metadata. The initial version of the media element can be augmented with a visual object rendered using the other multimodal scene graph and/or visual context rendered using the other multimodal scene graph. For example, the augmenting the initial version of the media element can include one or more of: replacing a background rendered using the multimodal scene graph with a background rendered using the other multimodal scene graph; and/or adding a visual object rendered using the other multimodal scene graph, the added visual object comprising an avatar that represents a person within the other recorded visual information.

At block 1008, process 1000 can publish the media element(s). For example, the media element(s) can be published to a social media platform and viewed by one or more social platform users. In some implementations, a social platform user may opt to access and edit a multimodal scene graph used to generate a given media element, for example to generate a variation of the given media element (e.g., a personalized version of the given media element).

FIG. 11 is a flow diagram illustrating a process 1100 used in some implementations of the present technology for editing a multimodal scene graph and rendering media element(s). Process 1100 can be performed at a XR system, cloud system, edge system, mobile device, smart home device, laptop, desktop, server, any other suitable computing device, or any combination thereof. Process 1100 can be triggered by user interactions related to generating media element(s), such as executing a social related application, media related application, triggering certain functionality of these applications, and the like.

At block 1102, process 1100 can load a multimodal scene graph. For example, a social platform user may load a multimodal scene graph in order to generate an edited multimodal scene graph. The edited multimodal scene graph can support customized and/or personalized variations of rendered media elements.

At block 1104, process 1100 can receive edits to the multimodal scene graph. For example, the edits can include deleting one or more component instances of the multimodal scene graph, deleting one or more pieces of metadata, and the like. In some implementations, the edits to the multimodal scene graph are performed using an other multimodal scene graph.

For example, an other recorded visual information can be processed, the other recorded visual information comprising one or more of a captured image, a captured video, or immersive data from a recorded artificial reality scene. An other multimodal scene graph can be stored, via the processing, comprising component data for one or more objects from the other recorded visual information and metadata. The edits to the loaded multimodal scene graph can include adding, to the multimodal scene graph, a visual object rendered using the other multimodal scene graph and/or visual context rendered using the other multimodal scene graph. In some implementations, the edited multimodal scene graph is generated by one or more of: replacing a background of the multimodal scene graph with a background of the other multimodal scene graph; and/or replacing a component of the multimodal scene graph with a component of the other multimodal scene graph, the replaced component comprising an avatar.

At block 1106, process 1100 can store the edited multimodal scene graph. For example, the edited multimodal scene graph can be stored such that one or more media elements can be rendered using the edited multimodal scene graph. In some implementations, the multimodal scene graph can be tailored and/or personalized to the social platform user that performed the editing.

At block 1108, process 1100 can generate one or more media element(s) using the edited multimodal scene graph. For example, an other media element can be rendered using the edited multimodal scene graph, where the other media element and the media element(s) rendered via the original (e.g., unedited) multimodal scene graph comprise similarities. In some implementations, the other media element (e.g., image, video, XR scene, etc.) includes one or more rendered visual objects that represent at least one of the one or more objects from the recorded visual information used to generate the original (unedited) multimodal scene graph and one or more rendered visual objects that represent at least one of the one or more objects from the other recorded visual information used to generate the edited multimodal scene graph.

At block 1110, process 1000 can publish the media element(s). For example, the media element(s) can be published to a social media platform and viewed by one or more social platform users. In some implementations, additional social platform users may opt to access and edit the edited multimodal scene graph used to generate a given media element. In some scenarios, a multimodal scene graph can be edited multiple times by multiple social platform users such that the edited scene graphs can support personalized and/or tailored media element generation for these users.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for generating a media element using a multimodal scene graph, the method comprising:
accessing a stored multimodal scene graph, wherein,
the multimodal scene graph is based on recorded visual information converted using one or more trained machine learning models, the recorded visual information comprising one or more of a captured image, a captured video, or immersive data from a recorded artificial reality scene, and
the multimodal scene graph comprises component data, for one or more objects of the recorded visual information, and metadata;
generating, using the multimodal scene graph, a media element, wherein,
the media element is an image or video, and
the media element includes one or more rendered visual objects that represent at least one of the one or more objects from the recorded visual information; and
publishing the media element on a social media platform, wherein one or more social platform users view the published media element.

2. The method of claim 1, wherein generating the media element further comprises:
generating an initial version of the media element that comprises the one or more rendered visual objects and one or more rendered visual context elements, wherein the one or more rendered visual context elements are generated using the metadata from the multimodal scene graph; and
augmenting, based on input from a user editor, the initial version of the media element to generate the media element.

3. The method of claim 2, wherein augmenting the initial version of the media element comprises one or more of:
replacing at least one of the one or more rendered visual context elements, the at least one replaced visual context element comprising a background;
deleting at least one of the one or more rendered visual objects;
adding one or more visual objects;
adding text or captions; and/or
adding one or more visual effects.

4. The method of claim 2, wherein augmenting the initial version of the media element comprises:
processing an other recorded visual information comprising one or more of a captured image, a captured video, or immersive data from a recorded artificial reality scene;
storing an other multimodal scene graph comprising component data for one or more objects from the other recorded visual information and metadata; and
augmenting the initial version of the media element with a visual object rendered using the other multimodal scene graph and/or visual context rendered using the other multimodal scene graph.

5. The method of claim 4, wherein the augmenting the initial version of the media element comprises one or more of:
replacing a background rendered using the multimodal scene graph with a background rendered using the other multimodal scene graph; or
adding a visual object rendered using the other multimodal scene graph, the added visual object comprising an avatar that represents a person within the other recorded visual information.

6. The method of claim 1, wherein,
the component data comprises visual information of a person, and
the one or more rendered visual objects comprise at least one rendered avatar that represents the person.

7. The method of claim 6, wherein,
the multimodal scene graph comprises movement data that corresponds to the person, and
the at least one rendered avatar is animated based on the movement data that corresponds to the person.

8. The method of claim 7, wherein converting the recorded visual information for the multimodal scene graph further comprises:
recognizing, using the one or more trained machine learning models, an object that corresponds to the person within the record visual information; and
generating, by the one or more trained machine learning models, the movement data that corresponds to the person data by identifying movements of the recognized object within the recorded visual information.

9. The method of claim 8, wherein the at least one rendered avatar is animated by:
converting the animation data into movement data with respect to the avatar, wherein the recognized object that corresponds to the person is associated with a detected structure, and the converting translates the animation data with respect to the detected structure into the movement data with respect to a predefined skeleton of the avatar.

10. The method of claim 1, wherein converting the recorded visual information for the multimodal scene graph further comprises:
recognizing, using the one or more trained machine learning models, an object that corresponds to a particular one of the one or more objects from the recorded visual information; and
generating, by the one or more trained machine learning models, pose data by identifying a pose of the recognized object, wherein the media element comprises a particular visual object that corresponds to the at least one particular component that is rendered using the generated pose data.

11. The method of claim 10, wherein the recognized object corresponds to a person, the particular visual object comprises an avatar for the person, the pose data comprise a body position for the recognized object, and the avatar is rendered in the body position.

12. The method of claim 1, wherein a social platform user accesses the multimodal scene graph and generates an edited multimodal scene graph, the edited multimodal scene graph being generated by:
processing an other recorded visual information comprising one or more of a captured image, a captured video, or immersive data from a recorded artificial reality scene;
storing an other multimodal scene graph comprising component data for one or more objects from the other recorded visual information and metadata; and
adding, to the multimodal scene graph, a visual object rendered using the other multimodal scene graph and/or visual context rendered using the other multimodal scene graph to generate the edited multimodal scene graph.

13. The method of claim 12, wherein the edited multimodal scene graph is generated by one or more of:
replacing a background of the multimodal scene graph with a background of the other multimodal scene graph; or
replacing a component of the multimodal scene graph with a component of the other multimodal scene graph, the replaced component comprising an avatar.

14. The method of claim 12, further comprising:
generating, using the edited multimodal scene graph, an other media element, wherein,
the other media element is an image or video, and
the other media element includes one or more rendered visual objects that represent at least one of the one or more objects from the recorded visual information and one or more rendered visual objects that represent at least one of the one or more objects from the other recorded visual information; and
publishing the other media element on the social media platform.

15. The method of claim 1, wherein,
the recorded visual information comprises three-dimensional (3D) information, and
the media element comprises a two-dimensional image or video rendered from a first perspective with respect to the 3D information.

16. A computer-readable storage medium storing instructions that, when executed by a computing system, cause the computing system to perform a process for generating a media element using a multimodal scene graph, the process comprising:
accessing a stored multimodal scene graph, wherein,
the multimodal scene graph is based on recorded visual information converted using one or more trained machine learning models, the recorded visual information comprising one or more of a captured image, a captured video, or immersive data from a recorded artificial reality scene, and
the multimodal scene graph comprises component data, for one or more objects of the recorded visual information, and metadata;
generating, using the multimodal scene graph, a media element, wherein,
the media element is an image or video, and
the media element includes one or more rendered visual objects that represent at least one of the one or more objects from the recorded visual information; and
publishing the media element on a social media platform, wherein one or more social platform users view the published media element.

17. The computer-readable storage medium of claim 16, wherein,
the component data comprises visual information of a person, and
the one or more rendered visual objects comprise at least one rendered avatar that represents the person.

18. The computer-readable storage medium of claim 17, wherein,
the multimodal scene graph comprises movement data that corresponds to the person, and
the at least one rendered avatar is animated based on the movement data that corresponds to the person.

19. The computer-readable storage medium of claim 18, wherein converting the recorded visual information for the multimodal scene graph further comprises:
recognizing, using the one or more trained machine learning models, an object that corresponds to the person within the record visual information; and
generating, by the one or more trained machine learning models, the movement data that corresponds to the person by identifying movements of the recognized object within the recorded visual information.

20. A computing system for generating a media element using a multimodal scene graph, the computing system comprising:
one or more processors; and
one or more memories storing instructions that, when executed by the one or more processors, cause the computing system to perform a process comprising:
accessing a stored multimodal scene graph, wherein,
the multimodal scene graph is based on recorded visual information converted using one or more trained machine learning models, the recorded visual information comprising one or more of a captured image, a captured video, or immersive data from a recorded artificial reality scene, and
the multimodal scene graph comprises component data, for one or more objects of the recorded visual information, and metadata;
generating, using the multimodal scene graph, a media element, wherein,
the media element is an image or video, and
the media element includes one or more rendered visual objects that represent at least one of the one or more objects from the recorded visual information; and
publishing the media element on a social media platform, wherein one or more social platform users view the published media element.
